(19) United States
(12) Patent Application Publication
(10) Pub. No.: US 2019/0294983 A1
(43) Pub. Date: Sep. 26, 2019

(54) MACHINE LEARNING INFERENCE ROUTING

(71) Applicant: Flybits Inc., Toronto (CA)

(72) Inventor: Hossein Rahnama, Toronto (CA)

(21) Appl. No.: 16/223,373

(22) Filed: Dec. 18, 2018

Related U.S. Application Data
(63) Continuation-in-part of application No. PCT/CA2018/050351, filed on Mar. 23, 2018.

(51) Int. Cl. G06N 5/04; G06N 20/00; G06F 16/901

(52) U.S. Cl. CPC G06N 5/043; H04L 67/42; G06F 16/9024; G06N 20/00

(57) ABSTRACT

According to embodiments described in the specification, an exemplary method and a system including a server is provided for performing a session handshake with an electronic device, receiving an intervention request and contextual data parameters from the electronic device, activating a subset of data sets and at least one Machine Learning (ML) container from a graph data structure maintained by the server, adjusting weight data parameters of the activated data sets, routing the activated data sets to the activated ML container or containers to generate a ML inference or inferences, and providing a notification of the result of the intervention request based on the generated ML inference or inferences.

### FIELD OF TECHNOLOGY

The present disclosure relates generally to techniques of machine learning. Certain embodiments provide a method and a system of machine learning inference routing.

### BACKGROUND

Machine learning (ML) techniques are used to make or support data-driven inferences (also referred to as predictions or decisions). However, when implementing ML for computer-assisted decision-making, it can be a difficult task to choose a suitable machine learning or ML framework from among many alternatives. The diversity of available ML frameworks, libraries, applications, toolkits, and datasets in the field of machine learning greatly increases the complexity of the task.

An ML framework selected for use via an Application Programming Interface or API to handle or support one type of decision making, or decision making in a specific context, may not be useful or as effective for other types of decision making, or in other contexts.

Furthermore, user interventions based on ML inferences are often opaque to the user in terms of the basis for the intervention and often do not provide any convenient mechanism to make adjustments to the inference.

Improvements in methods and systems for machine learning, and for providing user interventions based on machine learning inference routing are desirable.

The preceding examples of the related art and limitations related to it are intended to be illustrative and not exclusive. Other limitations of the related art will become apparent to those of skill in the art upon a reading of the specification and a review of the drawings.

### BRIEF DESCRIPTION OF THE DRAWINGS

The described embodiments may be better understood by reference to the following description and the accompanying drawings. Additionally, advantages of the described embodiments may be better understood by reference to the following description and accompanying drawings.

FIG. 1 is a block diagram of a system for machine learning inference routing in accordance with an example;

FIG. 2 is a schematic diagram of a graph data structure for machine learning inference routing in accordance with an example;

FIG. 3 is a block diagram of an electronic device for providing a user intervention based on machine learning inference routing in accordance with an example;

FIG. 4 is a flowchart illustrating a method of machine learning inference routing in accordance with an example; and

FIG. 5 is a view illustrating a client application screenshot in accordance with an example.

### DETAILED DESCRIPTION

Representative applications of methods and systems according to the present application are described in this section. These examples are being provided solely to add context and aid in the understanding of the described embodiments. It will thus be apparent to one skilled in the art that the described embodiments may be practiced without some or all these specific details. In other instances, well-known process steps have not been described in detail to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the scope of the described embodiments.

The following describes an exemplary method and system of machine learning inference routing. The method can be carried out by a server configured to perform a session handshake with an electronic device, receive an intervention request and contextual data parameters from the electronic device, activate a subset of data sets and at least one Machine Learning (ML) container from a graph data structure maintained by the server, adjust weight data parameters of the activated data sets, route the activated data sets to an activated ML container or containers to generate a ML inference or inferences, and provide a notification of the result of the intervention request based on the generated ML inference or inferences.

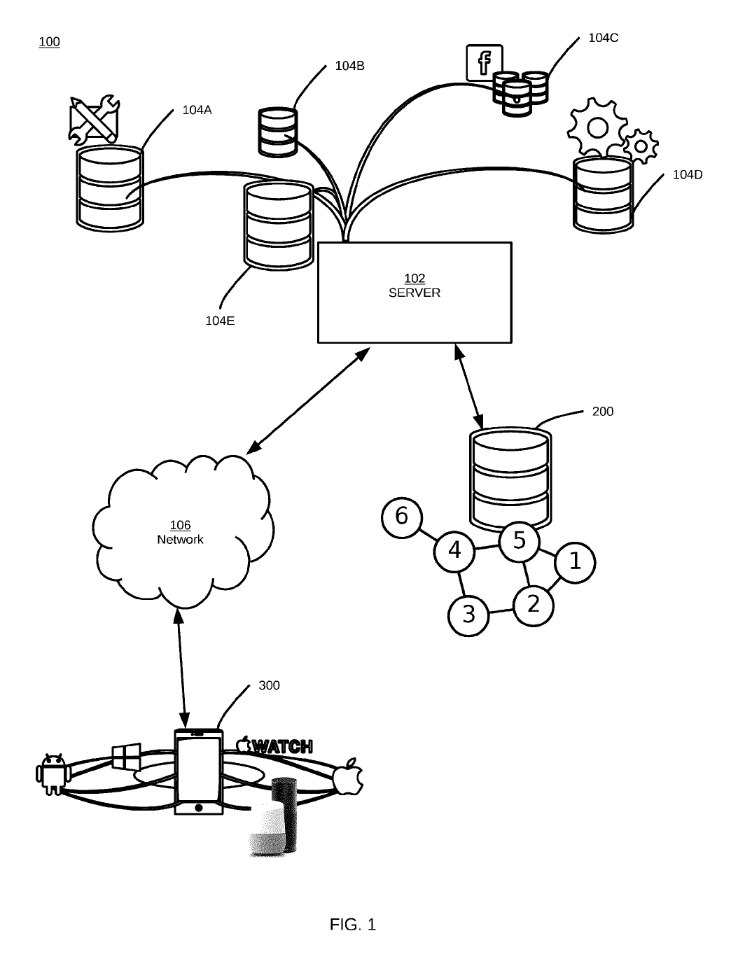

FIG. 1 illustrates a platform 100 for use with one or more electronic devices 300 according to a first example. According to this example, the platform 100 includes one or more electronic devices 300 (generically referred to herein as “electronic device 300” and collectively as “electronic devices 300”), all of which are connected to a server 102 via a network 106 such as the Internet.

Typically, the electronic devices 300 are associated with users who receive interventions from the server 102.

Generally speaking, the server 102 may be any entity that maintains data from a number of data sets 104 and that maintains a graph data structure 200 to process ML inference routing, discussed below in greater detail. The server 102 may host a website, application or service that allows the electronic device 300 or a user, such as a user at the electronic device 300, to make requests and receive interventions based on ML inference routing decisions.

Use of the term intervention in the present specification refers to any notification received via the electronic device 300 whether audio, visual, tactile, or another type of notification. For example, an intervention can be a push notification on an electronic device 300, an icon popping up on a display screen of the electronic device 300, an audio message played on a speaker of an electronic device 300, or a two-way notification such as a response to an elicitation that the user asks (e.g. “Hey Alexa, what credit card am I eligible for?”). According to some examples, an intervention can be triggered by an explicit request. Alternatively, an intervention can be passive or triggered by sensing an electronic device 300 is near or at a location of interest, such as a financial institution branch, or by sensing some other non-location based context data such as time of day, gender or other personal characteristics, availability (calendar), favorite song or other media items, and attributes or segments (from Customer Relationship Management software, Social Media profile) or similar. Use of the term contextual data in the present specification extends to any data describing the context or situation that the user of the electronic device 300 is in, including data describing the type of the user, the demography of the user, the geography of the user, correlation with historical data, and the like.

The server 102 is typically a server or mainframe within a housing containing an arrangement of one or more processors, volatile memory (i.e., random access memory or RAM), persistent memory (e.g., hard disk or solid state devices) (not shown), and a network interface device (to allow the server 102 to communicate over the network 106) (not shown) interconnected by a bus (not shown). Many computing environments implementing the server 102 or components thereof are within the scope of the present specification. The server 102 may include a pair (or more) of servers for redundancy or load-balancing purposes, connected via the network 106 (e.g., an intranet or across the Internet) (not shown). The server 102 may be connected to other computing infrastructure including displays, printers, data warehouse or file servers, and the like. The server 102 may include a keyboard, mouse, touch-sensitive display (or other input devices), a monitor (or display, such as a touch-sensitive display, or other output devices) (not shown in FIG. 1).

The server 102 may include a network interface device interconnected with the processor that allows the server 102 to communicate with other computing devices such as the electronic devices 300 via a link with the network 106. The network 106 may include any suitable combination of wired and/or wireless networks, including but not limited to a Wide Area Network (WAN) such as the Internet, a Local Area Network (LAN), HSPA/EVDO/LTE/5G cell phone networks, WiFi networks, and the like. The network interface device is selected for compatibility with the network 106. In one example, the link between the network interface device and the network is a wired link, such as an Ethernet link. The network interface device thus includes the necessary hardware for communicating over such a link. In other examples, the link between the server 102 and the network 106 may be wireless, and the network interface device may include (in addition to, or instead of, any wired-link hardware) one or more transmitter/receiver assemblies, or radios, and associated circuitry.

Still with reference to FIG. 1, the server 102 maintains one or more data sets 104. Each data set 104 maintains one or more electronic records and can be a database application loaded on the server 102, a stand-alone database server or a virtual machine in communication with the network interface device of the server 102, or any other suitable database.

The one or more data sets 104 can store disparate types of data. For example, a data set 104 may include data stored in a relational database such as real-time data and transactional data. Data from the data sets 104 may be normalized, that is, restructured in a normal form in order to reduce data redundancy and improve data integrity. Non-limiting examples of data sets 104 are shown in FIG. 1, by way of illustration, including office documents 104 A, one or more transactional databases 104B, social media content 104C, customer relationship management or CRM data 104D, and other content 104E. Typically, the server 102 may be coupled to each data set 104 over a bus or a network (such as network 106) and the server 102 may access or cache data from the data sets 104 at run-time, or at predetermined times, using an API (application program interface). The data sets 104 can be implemented within a wide variety of data structures that vary in complexity (e.g., fields, tables, strings, arrays, objects, etc.). Databases marketed by SAP, Oracle, J D Edwards are exemplary data sets 104.

With disparate data sets 104 containing data from different legacy systems, normalizing the data (from heterogeneous, to homogeneous) helps to make sure that the data from the data sets 104 can be combined, abstracted, tokenized (for privacy and security reasons) or otherwise leveraged. Generally, normalizing data permits a useful format that can be connected with other data sets 104 and logic created.

In one example, the server 102 may be integral with the electronic device 300. According to this example, at least some of the data sets 104 may be maintained directly on the electronic device 300, permitting user interfaces according to examples disclosed herein to be displayed and/or used in an “offline” mode.

Those having ordinary skill in the related arts will readily appreciate that the preceding system 100 is merely illustrative of the broader array of possible topologies and functions. Moreover, it should be recognized that various implementations can combine and/or further divide the various entities illustrated in FIG. 1.

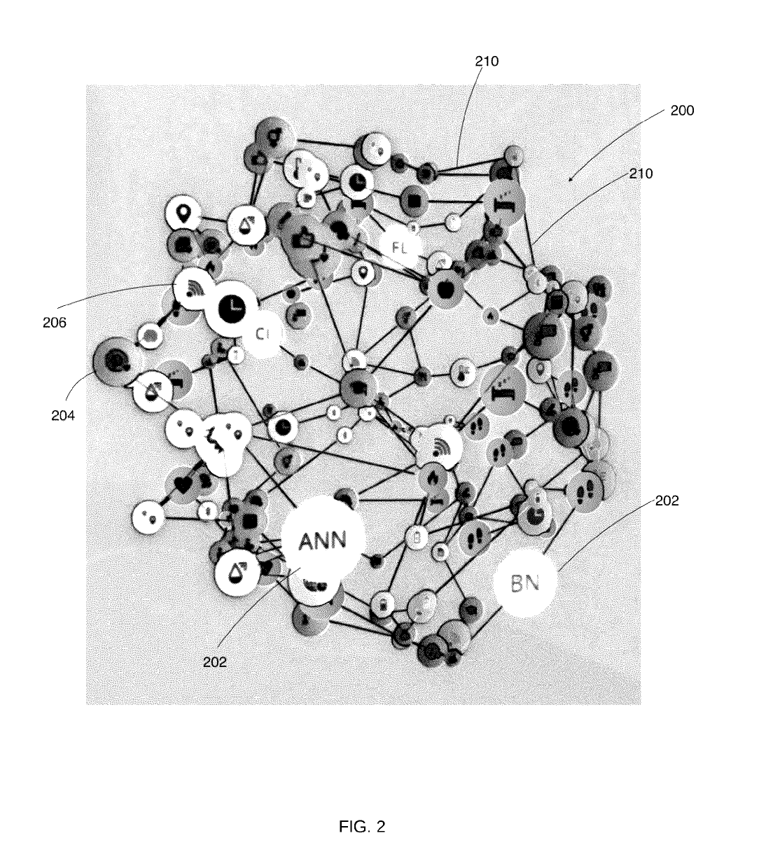

Now with reference to FIG. 2, the server also maintains a graph data structure 200. According to one example, the vertices of the graph data structure 200 include ML containers 202, data sets 204 (e.g., data sets 104 that have been normalized), contextual data 206 and other data 208. According to this example, the vertices of the graph data structure 200 are connected by edges that have weights (referred to as weight parameters in this specification). Initially, according to one example, the vertices (nodes) of the graph data structure 200 are associated with a normalized weight. After an inference is made and results are provisioned, optimization with training can be performed to adjust the weight parameters or other attributes of the graph data structure 200. The initial weighting of edges is subject to learning based on training data or scenarios can be defined manually.

As used in this specification a ML container 204 is a microservice or module implementing a specific ML approach (also referred to as inference vertices or nodes). A microservice can be implemented using a virtual machine or some other type of software module, including the format known as the Docker computer platform.

There are more than 30 different machine learning approaches. Each of them may be specific to a certain context. It has been discovered that ML experts often choose a ML approach based on previous experience and skill sets. It is an advantage to offer more than one ML approach in a complex data ecosystem. Existing ML approaches include: Decision tree learning, Association rule learning, Artificial neural networks, Deep learning, Inductive logic programming, Support vector machines, Clustering, Bayesian networks, Reinforcement learning, Representation learning, Similarity and metric learning, Sparse dictionary learning, Genetic algorithms, Rule-based machine learning, Learning classifier systems, among others.

According to one example, the ML containers 202 can be stored or executed on one or more virtual machines. As is known in the art, a virtual machine is an execution environment (typically on a server) that has access to one or more processors, memory, disk drives, network interface cards, and so on. While one or more virtual machines can be instantiated on a single server, the processes of two different virtual machines typically do not interfere with one another (i.e., one virtual machine will not write over the data of another virtual machine, etc.) In the present case, one or more of the ML container functions may be executed on a virtual machine, for example, provided by Amazon Web Services (AWS), Microsoft Azure, or another cloud service.

Those having ordinary skill in the related arts will appreciate that the graph data structure 200, that is, the vertices (data sets and ML containers) and edges (weight parameters), when adjusted based on contextual data parameters, define relevant semantic entities (e.g., a subset of the data sets 204) and an ontology describing the importance of the semantic entities (e.g., adjusted weight parameters) and the logic to make or support inferences through selection of a ML container or containers. The ontology defines how the graph data structure 200 is to be navigated. It will be appreciated that ontologies can be stored, adjusted and maintained by the server 102 as Web Ontology Language (OWL) templates or documents or any other format that is suitable to store or represent ontologies.

It should be noted that for the context of this discussion, embodiments throughout this disclosure describe machine learning taking the form of any technique, heuristic or method to fulfill the functions of generating or supporting a decision, prediction or classification, for example, supervised learning, unsupervised learning, reinforcement learning, among others. More generally, machine learning refers to any learning or problem solving technique that is implemented in a machine or electronic device. It should be understood that this description is not limiting and that the described embodiments can be used to apply to any domain of computer-assisted reasoning, knowledge, planning, learning, language processing, perception or movement/manipulation of objects. The result or output of a ML inference depends on the model selected and can be a classification, a recommendation, a discrete or continuous output, a mapping, any other type of decision or a probability factor that supports decision making.

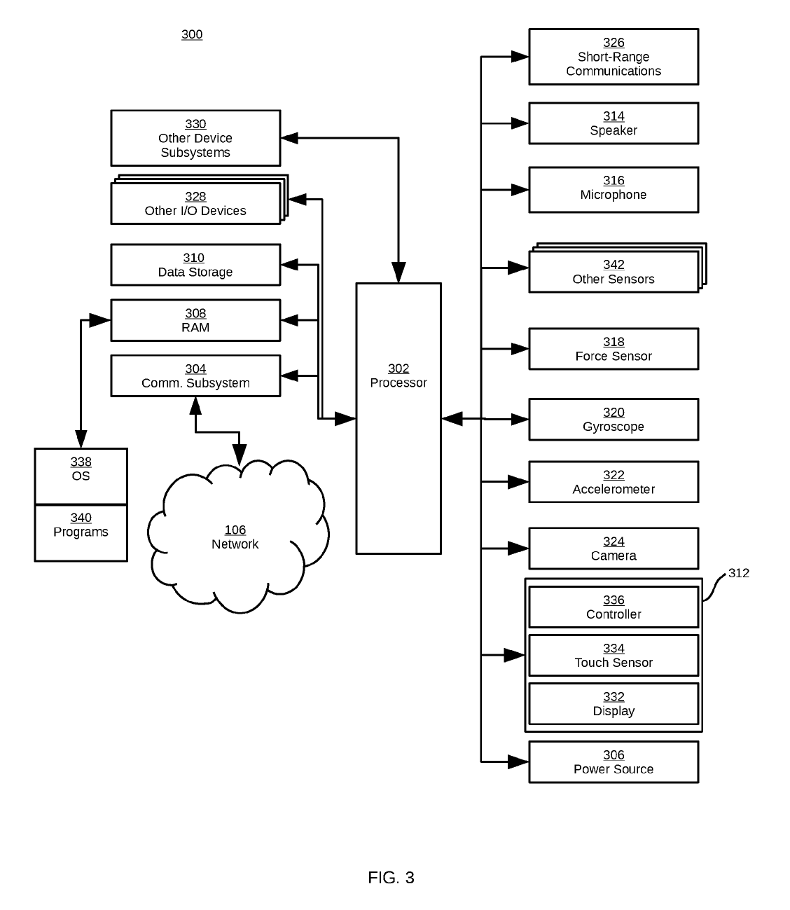

Turning now to FIG. 3, a block diagram of an example of an electronic device 300, also referred to as a device, is shown in FIG. 3. The electronic device 300 may be any of a desktop computer, smart phone, laptop computer, tablet computer, smart watch or other wearable device, Internet of Things appliance or device, virtual reality headset, augmented reality device, intelligent personal assistant (including those marketed under the brand names Siri, Alexa or Home) and the like. According to one example, the electronic device 300 includes multiple components, such as a processor 302 that controls the overall operation of the electronic device 300. Communication functions, including data and voice communications, are performed through a communication subsystem 304. The communication subsystem 304 receives messages from and sends messages to a network 106. The network 106 may be any type of wired or wireless network, including, but not limited to, data wireless networks, voice wireless networks, and networks that support both voice and data communications. A power source 306, such as one or more rechargeable batteries or a port to an external power supply, powers the electronic device 300.

The processor 302 interacts with other components, such as a Random Access Memory (RAM) 308, data storage 310 (which may be cloud storage), a touch-sensitive display 312, a speaker 314, a microphone 316, one or more force sensors 318, one or more gyroscopes 320, one or more accelerometers 322, one or more cameras 324 (such as front facing camera 324a and back facing camera 324b), short-range communications subsystem 326, other I/O devices 328 and other subsystems 330. The touch-sensitive display 312 includes a display 332 and touch sensors 334 that are coupled to at least one controller 336 utilized to interact with the processor 302. According to one example, input via a graphical user interface can be provided via the touch-sensitive display 312. Alternatively, according to a different example, input can be provided via elicitation using the microphone 316.

Information, such as text, characters, symbols, images, icons, and other items that may be displayed or rendered on a mobile device, is displayed on the touch-sensitive display 312 via the processor 302. The electronic device 300 may include one or more sensors 342, such as micro-sensors using MEMS technology.

The touch-sensitive display 312 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth. As mentioned above, the capacitive touch-sensitive display includes one or more capacitive touch sensors 334. The capacitive touch sensors may comprise any suitable material, such as indium tin oxide (ITO).

The electronic device 300 includes an operating system 338 and software programs, applications, or components 340 that are executed by the processor 302 and are typically stored in a persistent, updatable store such as the data storage 310. Additional applications or programs may be loaded onto the electronic device 300 through the wireless network 106, the short-range communications subsystem 326, or any other I/O devices 328 or subsystem 330.

The electronic device 300 includes a context engine (not shown) that senses or infers contextual data parameters (semantic or ontologic data) around the electronic device 300. Contextual data parameters are processed by the server 102. In one example, the contextual data parameters can extend to information from proprietary or public data sets 104 or from sensors of one or more electronic devices 300 carried by the user (e.g. smartphone and wearable). Sensors of an electronic device 300 can extend to a touch-sensitive display, a microphone, a location service, a camera, an accelerometer, a gyroscope, a light sensor, a digital compass, a magnetometer, a barometer, a biometric service, and the like.

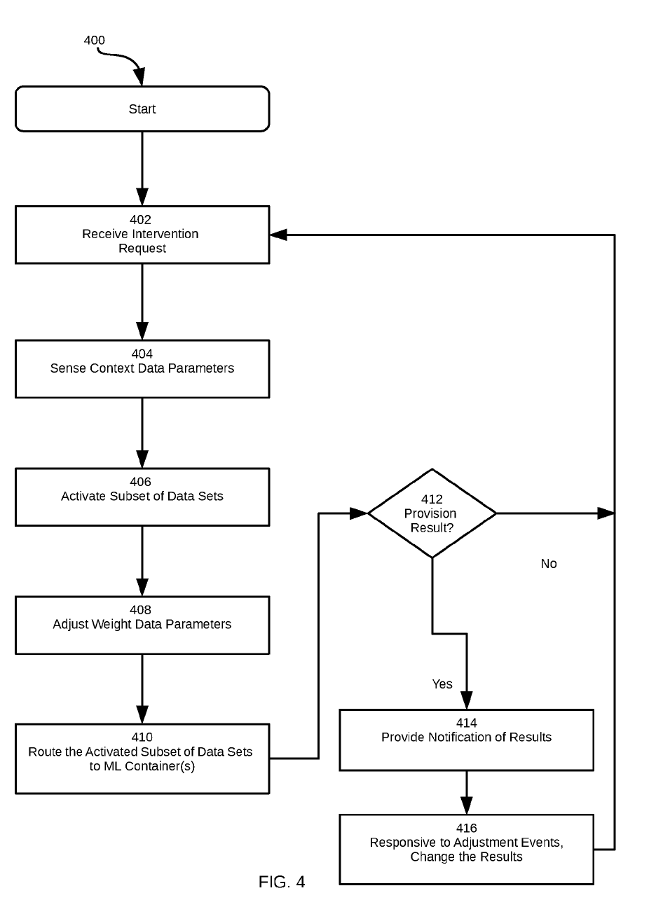

A flowchart illustrating an example of a method of machine learning inference routing based on an intervention request from an electronic device 300 is shown in FIG. 4. The method may be carried out by software executed by, for example, processor 302 or server processor. Coding of software for carrying out such a method is within the scope of a person of ordinary skill in the art given the present description. The method may contain additional or fewer processes than shown and/or described, and may be performed in a different order. Computer-readable code executable by at least one processor of the electronic device 300 (or server) to perform the method may be stored in a computer-readable storage medium, such as a non-transitory computer-readable medium.

When an intervention request is received at the server 102 from the electronic device 300 at 402, contextual data parameters 404 are sensed at 404. Contextual data parameters include sensed data parameters from one or more sensors of the electronic device 300. Sensors can include location services, calendar services, weather services, health services, user activity services, and the like. Contextual data parameters of the electronic device 300 may include one or more location services. Use of the term “location services” in the present specification may refer to any cellular, Wi-Fi, Global Positioning System (GPS), and/or Bluetooth data of the electronic device 300 that may be used to determine approximate location of the electronic device 300. If location data is not available, as when a new electronic device 300 has been activated, a default template can be used, and the method continues. Based on the sensed contextual data parameters, at 406, a subset of data sets 104 is activated including selection of one or more ML containers and, at 408, weight parameters are adjusted. At 410, the request and the activated data sets are routed to the ML container to generate an inference. At 412, when a result has been provisioned, notification of the result is forwarded to the electronic device 300 at 414 (e.g., for display or announcement). At 416, the result can be adjusted by use of a user interface.

Use of the techniques disclosed herein permits the sensing of contextual data parameters and provisioning of interventions that are responsive and tailored to the context of an electronic device 300.

Advantageously, through containerization of ML containers, new and additional ML containers can be added in real-time and without re-architecting the system 100. As well, the graph data structure 200 is able to act as a protocol for absorbing ML inferences, permitting the combining and embedding of contextual (situational) awareness in making inferences and supporting decision-making.

Use of the disclosed examples permits an organization to build an infrastructure, that is, an orchestration of data, that allows the scaling of ML capabilities through normalization of new or additional data and containerization of new or additional ML solutions. New or different ML techniques and/or data sets can be included as they are developed or over time as an organization's data needs evolve or change.

As well, ML capabilities can be added without adjusting for idiosyncratic technology stacks. A data owner such as a financial institution can employ or leverage multiple ML solutions and expose all of them to the graph data structure 200. Each ML container represents a different ML approach such as learning/neural network model, Bayesian networks, etc. Use of the disclosed examples permits the architecting of a scalable, embedded recommendation engine.

Furthermore, an organization could route an inference to more than one ML container. For example, two ML containers could be configured to recommend a “next best offer” such as Support Vector Machines and Neural Network. The system 100 could route an inference to both ML containers and evaluate the result to determine which ML container provides a better result, or to provide a hybrid result. According to this example, the graph data structure 200 acts can be represented as a three-dimensional or spatial data structure. According to this example, the ontology or activated graph data structure 200 selects multiple ML containers for evaluation to help the electronic device 300 user make a better decision.

Scenario 1. An urban professional user is in a retail store and applying for a credit card product. Based on the contextual data parameters (ontology), a graph data structure is created or adjusted (e.g., data sets are eliminated and weights are adjusted). In this example, information such as the user's credit score has a higher weight, meaning that the weight parameter relating to credit score (from the data sets 104) will be very close to 1. The inference is routed to a Bayesian Belief Network ML container. A Bayesian Belief ML approach is pre-defined for use in contexts involving risk assessment. A notification of an intervention is provided to the user's electronic device.

Scenario 2. If the same user changes context, and is looking for a product recommendation, the contextual data parameters (ontology) are different. The graph data structure is adjusted (e.g., data sets are eliminated and weights are adjusted). The inference is routed to a Neural Network ML container. A Neural Network ML approach is pre-defined for use in contexts involving “next best product” decisions. A notification of an intervention is provided to the electronic device 300. While prior solutions based on correlation of the user's purchase history, the user's location, and the user's demographic information can provide a recommendation, the approach described above can take advantage of many contextual data parameters including what types of persons the user met with (via calendar or location services), the health of the user (e.g., is the user tired), the subjects that the user discussed, and so on.

Scenario 3. A public transit ontology determines relevant data sets (semantic entities) such as Trains, Passengers, Delays, Platforms, etc. The graph data structure is adjusted (e.g., data sets are eliminated and weights are adjusted).

Scenario 4. A first year banking student customer at Orientation week. Relevant data sets (semantic entities) include credit scores, academic information, duration of time that the customer has had an account, user's location. The graph data structure is adjusted (e.g., data sets are eliminated and weights are adjusted).

According to disclosed examples, interventions presented to the user on an electronic device 300 can be adjusted. According to current approaches, if an offer is presented to a user, often the user has little or no idea why the offer was made. This can result in a user losing trust in the offer or the entity providing the offer. When the user is able to adjust an input or inputs to the intervention, then the graph data structure 200 (e.g., a weight parameter) can be adjusted. For example, if an intervention is made to suggest a credit card with loyalty program X, and a different loyalty program is desired by the user, then the notification based on the initial inference can be adjusted while the rest of the inference stays the same. According to disclosed examples, the result or outputs of any type of decision can be digitized and made available for adjustment. An intuitive user interface tool is provided to adjust the inference after seeing (or hearing) the recommendation (intervention) as a result of the inference. The user interface tool can take the form of presenting an additional/different recommendation, a slider tool (for electronic devices 300 with a display), a questionnaire, or any other input technique.

Advantageously, user of the electronic devices 300 can be provided with some awareness of the factors affecting a ML inference, providing a ML decision support system.

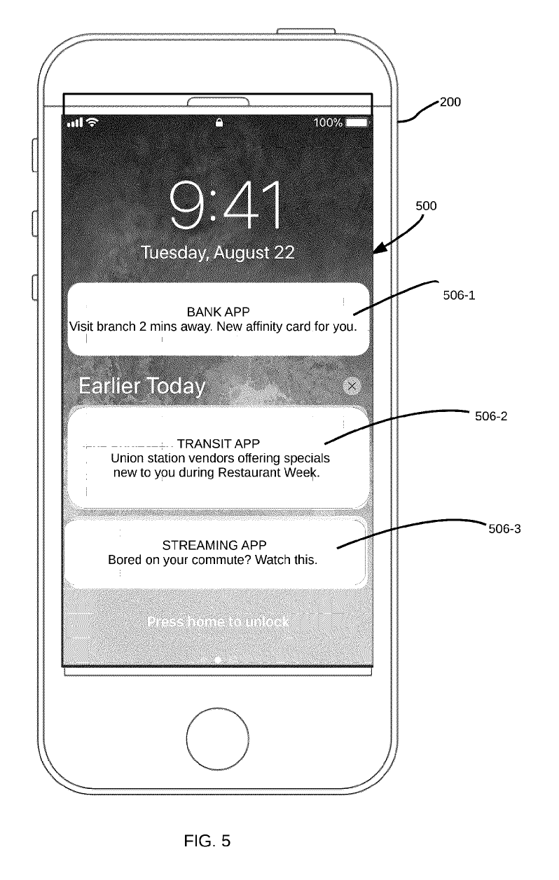

Examples of screenshots on the display of the client device 102 when loaded with an application to operate in accordance with the present disclosure are depicted in FIG. 5 and described with continued reference to FIG. 4.

With reference to FIG. 5, screenshot 500 may be launched by accessing the client device 102. In one example, the application may require user authentication to proceed further. A list of relevant notifications is shown including notifications at areas 506-1, 506-2 and 506-3. Touching or clicking on a location 506 provides an interface to accept or further interact with the notification of intervention.

The present specification discloses a method of machine learning inference routing including the steps of maintaining, in a memory of a remote server, a graph data structure made up of one or more data sets, one or more ML containers and one or more weight data parameters, wherein each weight data parameter associates one or more data items from the one or more data sets with the one or more ML containers, receiving, at the remote server, an intervention request from a first electronic device, sensing contextual data parameters associated with the first electronic device, activating a subset of the one or more data sets and at least one of the one or more ML containers from the graph data structure based on the sensing, adjusting one or more weight data parameters of the activated data sets based on the sensing, routing the subset of activated data sets to the ML container to generate a ML inference, provisioning a result of the intervention request based on the generated ML inference, and providing a notification of the result on the first electronic device.

According to one example, the sensing step can include: determining one or more semantic data entities for activating some of the one or more data items from the one or more data sets, and determining one or more ontology templates for adjusting the weight data parameters of the activated data sets. The ontology template can be selected from a database of OWL documents describing a plurality of ontologies.

In one example, at least two ML containers from the graph data structure are activated based on the sensing. The subset of activated data sets are routed to the two ML containers to generate a first ML inference and a second ML inference. The result of the intervention request is based on a hybrid of the generated ML inferences.

The ML containers can be one or more of: a decision tree learning ML container, an association rules learning ML container, an artificial neural networks ML container, a deep learning ML container, an inductive logic programming ML container, a support vector machines ML container, a clustering ML container, a Bayesian networks ML container, a reinforcement learning ML container, a representation learning ML container, a similarity and metric learning ML container, a sparse dictionary learning ML container, a genetic algorithm ML container, and a rule-based machine learning ML container.

In accordance with an example, the ML container can include a virtual machine specifying API conditions including routines, data structures, object classes, and variables.

Each data set can include a normalized data set for reducing the stored structural complexity of the one or more data sets.

According to various examples, the electronic device can be a smartphone or wearable device with sensors such as a touch-sensitive display, a microphone, a location service, a camera, an accelerometer, a gyroscope, a light sensor, a digital compass, a magnetometer, a barometer, a biometric service. The contextual data parameters can include data parameters sensed from the sensors.

The notification step can include scheduling the notification based on a time parameter and a location parameter and displaying a message on the touch-sensitive display based on the scheduling. After displaying the message, and receiving user input, the ML inference can be adjusted based on the user input and provisioned to the electronic device.

According to an alternative example, when the electronic device is a home assistant device including a location service and a microphone. According to one example, the notification step can include scheduling the notification based on a time parameter and a location parameter, and announcing a message using a speaker of the home assistant device based on the scheduling. After announcing the message, and listening for user input, the ML inference can be adjusted based on the user input and provisioned to the electronic device.

The electronic device can be one of a desktop computer, a laptop computer, a tablet computer, a smart phone, a wearable device, a virtual reality headset, an augmented reality device, a voice assistant device, and an Internet of Things device.

According to one example, a server includes a processor and a memory operable to store instructions that, when executed by the processor, causes the server to maintain, in the memory, a graph data structure made up of one or more data sets, one or more ML containers and one or more weight data parameters, wherein each weight data parameter associates one or more data items from the one or more data sets with the one or more ML containers, perform a session handshake with a remote first electronic device, receive an intervention request and contextual data parameters from the first electronic device, activate a subset of the one or more data sets and at least one of the one or more ML containers from the graph data structure based on the intervention request and the contextual data parameters, adjust one or more weight data parameters of the subset of activated data sets, route the subset of activated data sets to the at least one of the one or more ML containers to generate a ML inference, provision a result of the intervention request based on the generated ML inference, and transmit, to the first electronic device, the result of the intervention request for notification.

It will be recognized that while certain features are described in terms of a specific sequence of steps of a method, these descriptions are only illustrative of the broader methods disclosed herein, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure and claimed herein.

Furthermore, the various aspects, embodiments, implementations or features of the described embodiments can be used separately or in any combination. Various aspects of the described embodiments can be implemented by software, hardware or a combination of hardware and software. The described embodiments can also be embodied as computer-readable code on a computer-readable medium. The computer-readable medium is any data storage device that can store data which can thereafter be read by a computer system. Examples of the computer-readable medium include read-only memory, random-access memory, CD-ROMs, HDDs, DVDs, magnetic tape, and optical data storage devices. The computer-readable medium can also be distributed over network-coupled computer systems so that the computer-readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A method of machine learning inference routing comprising the steps of:
maintaining, in a memory of a remote server, a graph data structure comprising one or more data sets, one or more ML containers and one or more weight data parameters, wherein the one or more weight data parameters associates one or more data items from the one or more data sets with the one or more ML containers;
receiving, at the remote server, an intervention request from a first electronic device;
sensing contextual data parameters associated with the first electronic device;
activating a subset of the one or more data sets and at least one of the one or more ML containers from the graph data structure based on the sensing;
adjusting one or more weight data parameters of the subset based on the sensing;
routing the subset of the one or more data sets to the at least one of the one or more ML containers to generate a ML inference;
provisioning a result of the intervention request based on the ML inference; and
providing a notification of the result on the first electronic device.

2. The method of claim 1 wherein the sensing comprises:
determining one or more semantic data entities for activating some of the one or more data items from the one or more data sets; and
determining one or more ontology templates for adjusting the weight data parameters of the activated data sets.

3. The method of claim 2 wherein the ontology template is selected from a database of OWL documents describing a plurality of ontologies.

4. The method of claim 1 wherein the graph data structure comprises at least two or more ML containers, the method further comprising
activating at least two of the two or more ML containers from the graph data structure based on the sensing;
routing the subset of the one or more data sets to the at least two of the two or more ML containers to generate a first ML inference and a second ML inference; and
provisioning a result of the intervention request based on a hybrid of the first ML inference and the second ML inference.

5. The method of claim 2 wherein the one or more ML containers are selected from: a decision tree learning ML container, an association rules learning ML container, an artificial neural networks ML container, a deep learning ML container, an inductive logic programming ML container, a support vector machines ML container, a clustering ML container, a Bayesian networks ML container, a reinforcement learning ML container, a representation learning ML container, a similarity and metric learning ML container, a sparse dictionary learning ML container, a genetic algorithm ML container, and a rule-based machine learning ML container.

6. The method of claim 5 wherein the ML container comprises a virtual machine specifying API conditions comprising routines, data structures, object classes, and variables.

7. The method of claim 6 wherein the data set comprises a normalized data set for reducing the stored structural complexity of the one or more data sets.

8. The method of claim 7 wherein the first electronic device is selected from one of a smartphone and a wearable device comprising a plurality of sensors selected from: a touch-sensitive display, a microphone, a location service, a camera, an accelerometer, a gyroscope, a light sensor, a digital compass, a magnetometer, a barometer, a biometric service, and wherein the contextual data parameters comprise data parameters sensed from the plurality of sensors.

9. The method of claim 8 wherein the providing a notification step comprises:
scheduling the notification based on a time parameter and a location parameter; and
displaying a message on the touch-sensitive display based on the scheduling.

10. The method of claim 9 further comprising:
after displaying the message, receiving user input;
adjusting the ML inference based on the user input;
provisioning an adjusted result of the intervention request based on the adjusted ML inference; and
providing a notification of the adjusted result on the first electronic device.

11. The method of claim 7 wherein the first electronic device is a home assistant device comprising a plurality of sensors selected from: a location service and a microphone, and wherein the contextual data parameters comprise data parameters sensed from the plurality of sensors.

12. The method of claim 11 wherein the providing a notification step comprises:
scheduling the notification based on a time parameter and a location parameter; and
announcing a message using a speaker of the home assistant device based on the scheduling.

13. The method of claim 12 further comprising:
after announcing the message, listening for user input;
adjusting the ML inference based on the user input;
provisioning an adjusted result of the intervention request based on the adjusted ML inference; and
providing a notification of the adjusted result on the first electronic device.

14. The method of claim 7 wherein the first electronic device is selected from one of: a desktop computer, a laptop computer, a tablet computer, a smart phone, a wearable device, a virtual reality headset, an augmented reality device, a voice assistant device, and an Internet of Things device.

15. A server comprising: a server processor; and a server memory operable to store instructions that, when executed by the sever processor, causes the server to:
maintain, in the server memory, a graph data structure comprising one or more data sets, one or more ML containers and one or more weight data parameters, wherein the one or more weight data parameters associates one or more data items from the one or more data sets with the one or more ML containers;
perform a session handshake with a remote first electronic device, receive an intervention request and contextual data parameters from the first electronic device;
activate a subset of the one or more data sets and at least one of the one or more ML containers from the graph data structure based on the intervention request and the contextual data parameters;
adjust one or more weight data parameters of the subset of the one or more data sets;
route the subset of the one or more data sets to the at least one of the one or more ML containers to generate a ML inference;
provision a result of the intervention request based on the ML inference; and
transmit, to the first electronic device, the result of the intervention request for notification.
